(19) United States
(12) Patent Application Publication
(10) Pub. No.: US 2004/0081220 A1
(43) Pub. Date: Apr. 29, 2004

(54) Controlled atmosphere furnace and heating method thereof

(76) Inventor: Takanori Takeda, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/687,725

(22) Filed: Oct. 17, 2003

(30) Foreign Application Priority Data
Oct. 25, 2002 (JP) 2002-311204

(51) Int. Cl. H05B 3/00

(52) U.S. Cl. 373/109

(57) ABSTRACT

In the inventive controlled atmosphere furnace, an article 11 conveyed through a preheating chamber 1 prior to being brazed is quickly heated with combustion gas circulating in a closed-loop flow path through the preheating chamber to approximately 450° C. within the approximately five minutes determined in view of the deterioration degree of flux in the atmosphere and the growth of an oxide layer on the article. A gas burner 71 and a circulation fan 6 are provided in the closed-loop flow path, and the combustion rate of the gas burner and the circulation rate of the combustion gas due to the circulation fan are controlled based on the chamber temperature detected by a temperature sensor 9 in the preheating chamber.

### BACKGROUND OF THE INVENTION

1. Field of the Invention

The present invention relates to a controlled atmosphere furnace for carrying out a heat treatment or a brazing operation in an atmosphere within the furnace and a heating method thereof.

2. Description of the Related Art

In the prior art, when parts of a heat exchanger such as fins or others are brazed, a closed controlled atmosphere furnace of a large-size, as shown in FIG. 3, has been required. The reasons therefor are as follows. Flux necessary for the brazing deteriorates as time passes as shown in FIG. 4 and the oxidation of the heat exchanger part progresses to make the removal of an oxide layer impossible, which means that the maximum heating time in the atmospheric environment is approximately 5 minutes. To suppress the deterioration of flux as well as the growth of oxide layer, a closed furnace with a nitrogen gas atmosphere has been required.

That is, the conventional controlled atmosphere furnace is provided with a preheating chamber A and a brazing chamber B sequentially disposed along the conveying path for articles G to be heated, such as heat exchanger parts or others transported by a conveyor device E, as shown in FIG. 3. The chambers A and B are shut by atmosphere shutter doors C and D disposed forward and rearward of the chambers A and B, respectively. In this regard, electric heaters F are provided in the preheating chamber A as heating means, and the interior of the preheating chamber A and the brazing chamber B contains a nitrogen gas atmosphere. If the preheating is carried out in such conventional controlled atmosphere furnace prior to the brazing, the article G such as an heat exchanger including tubes, fins or others requires much time until the temperature thereof sufficiently rises as it is heated by radiation heat from the electric heater F. Therefor, to facilitate the production efficiency, it is necessary to preheat a number of articles 7, which requires the use of a large-sized (long) furnace.

To reduce a size of the furnace body, to solve the above problem, a high-speed agitation of a nitrogen gas atmosphere has been tried. However, this results in a new problem of much leakage of nitrogen gas and, to prevent such leakage, the construction of the furnace becomes complex. Also, as an electric heater capable of heating without oxygen is used as a heat source, there has been an essential problem in that the conversion of energy source to one effective for the reduction of CO₂ is impossible. While the conversion of energy source (from electricity to gas) is effective for reducing CO₂, it requires heat exchange between nitrogen gas and combustion gas during the heating of the article, which enlarges and complicates the construction of the furnace and increases a heat loss in comparison with the prior art. Thus, the conversion of a heat source to a gas has been difficult.

Also, in the prior art using a gas as a heat source, a controlled atmosphere furnace is provided with a preheating chamber for heating the article by using combustion gas ejected from a curtain burner (see Japanese Unexamined Patent Publication No. 53-138910).

According to this known controlled atmosphere furnace, the combustion gas flows from downstream to upstream as seen in the transporting direction of the article to be heated in the preheating chamber, so that outer air is prevented from entering the furnace and the atmospheric gas is prevented from flowing out from the furnace, and as the article is preheated.

As this known controlled atmosphere furnace, however, has a structure for simply discharging the combustion gas from the preheating chamber, the heat of the combustion gas could not be effectively used. Also, as the preheated temperature and time in the preheating chamber are not controlled, there is a risk of the deterioration of flux and the growth of an oxide layer as described above.

### SUMMARY OF THE INVENTION

The present invention has been made in view of the above-mentioned problems, and an object thereof is to provide a controlled atmosphere furnace, and a heating method thereof, capable of preheating an article to be brazed at a high speed and preventing the deterioration of flux and the growth of oxide layer even though the atmosphere in the preheating chamber is not a non-oxygen atmosphere.

According to a controlled atmosphere furnace of one aspect of the present invention, the article passing through a preheating chamber prior to being brazed is quickly preheated to a temperature closer to a predetermined value within a predetermined period by the combustion gas circulating the preheating chamber. Thereby, even in the non-oxygen atmosphere, the article could be preheated while the deterioration of the flux and the growth of the oxide layer are avoided. Also, by circulating the combustion gas, heat could be effectively used to realize minimization (shortening) of a furnace body, energy saving and reduction of CO₂ due to the conversion of heat source to gas.

According to the inventive controlled atmosphere furnace, a gas burner and a circulation fan are provided in a path of a closed loop for the combustion gas. According to the inventive controlled atmosphere furnace, the gas burner and the circulation fan are controlled to quickly preheat the article. In such a manner, it is possible to precisely preheat the article to a predetermined temperature within a predetermined period by controlling ON/OFF of the gas burner and forcibly increasing or decreasing the circulation rate of the combustion gas based on the temperature in the preheating chamber.

According to the inventive controlled atmosphere furnace, the delivery speed of a conveyor device is controlled so that the article can pass through the preheating chamber within a predetermined period. Thereby, it is possible to complete the preheating during the transportation without stopping the conveyor device.

According to the inventive controlled atmosphere furnace, an atmosphere shutter chamber is formed of a plurality of metallic curtains. It is possible to sufficiently seal the atmospheric gas even by such a simple sealing structure.

According to the inventive controlled atmosphere furnace, the predetermined period is defined as approximately five minutes and the predetermined temperature is defined as approximately 450° C. in view of the degree of deterioration of brazing flux as well as the growth of oxide layer in the article to be heated. Thereby, it is possible to complete the preheating of the article by the combustion gas prior to the deterioration of flux and the growth of oxide layer without making the atmosphere a non-oxygen atmosphere.

According to the inventive controlled atmosphere furnace, a nozzle at a tip end of the circulation duct forming a closed loop for circulating the combustion gas is opened toward a portion of the article required to be heated. Thereby, it is possible to increase the temperature of that portion at a high rate.

According to a method for heating the controlled atmosphere furnace in another aspect of the present invention, the article is quickly preheated within a certain period determined in view of the deterioration degree of brazing flux and the growth of oxide layer on the article in the atmosphere, by the forced circulation of the combustion gas. Thereby, it is possible to preheat the article by the combustion gas in the atmosphere containing oxygen in a short time, which means that the articles can be preheated one by one during the brazing process even in a smaller furnace body. Also, as the preheating means is converted from electricity to gas, it is possible to reduce CO₂.

According to the inventive heating method, the time is approximately five minute and the temperature is approximately 450° C.

The present invention may be more fully understood from the description of the preferred embodiments of the invention, as set forth below, together with the accompanying drawings.

### BRIEF DESCRIPTION OF THE DRAWINGS

In the drawings:

FIG. 1 is a schematic front view of an overall structure of the inventive controlled atmosphere furnace, and a side view of a preheating chamber;

FIG. 2 is graphs showing the relationship between the temperature increase of an article to be heated in a preheating chamber and the heating time and the relationship between the deterioration degree of flux and the growth of oxide layer in the atmosphere and the heating time, respectively, according to the inventive method;

FIG. 3 illustrates a schematic overall structure of a prior art controlled atmosphere furnace;

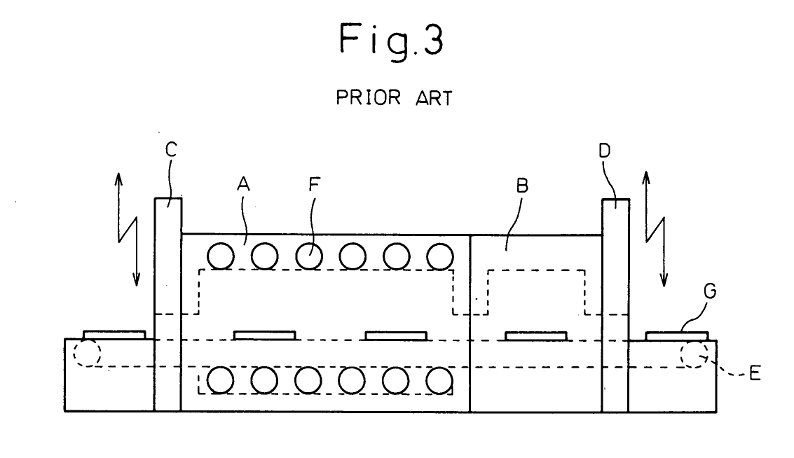

FIG. 4 is graphs showing the relationship between the temperature increase of an article to be heated in a preheating chamber and the heating time and the relationship between the deterioration degree of flux and the growth of oxide layer in the atmosphere and the heating time, respectively, in the prior art controlled atmosphere furnace; and

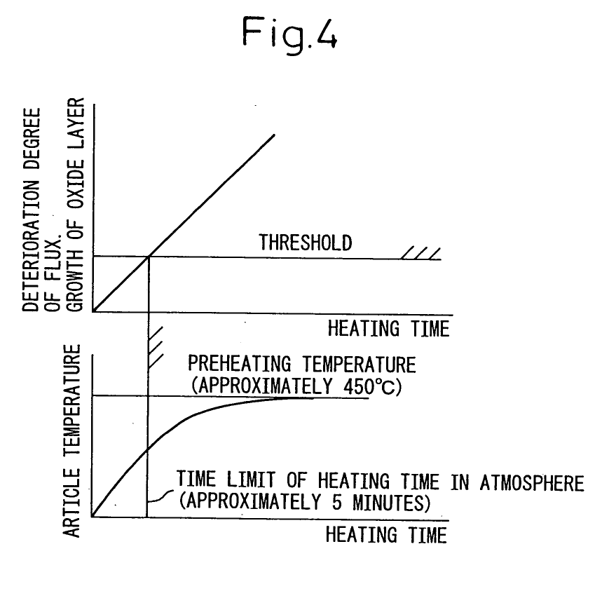

FIG. 5 illustrates a heat exchanger which is a proper example of an article to be heated in the inventive controlled atmosphere furnace.

### DESCRIPTION OF THE PREFERRED EMBODIMENTS

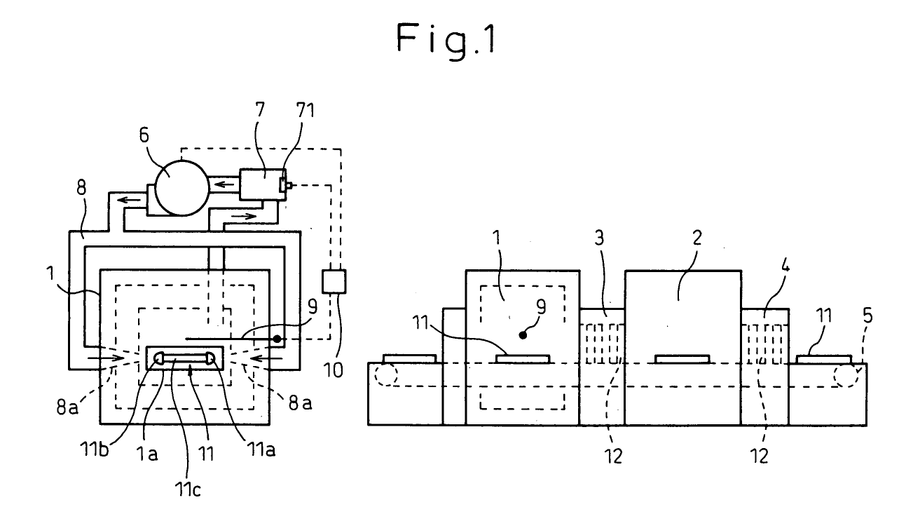

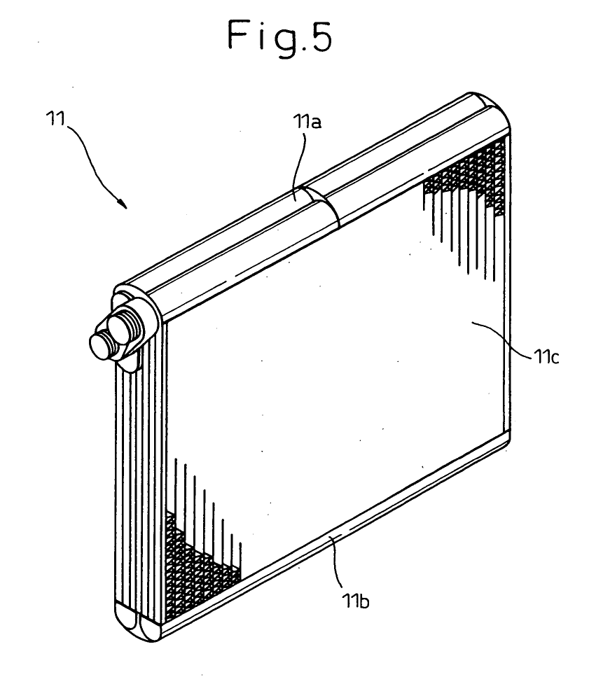

One embodiment of the inventive controlled atmosphere furnace and a heating method thereof will be described below with reference to the attached drawings. FIG. 1 is a schematic front view of an overall structure of the inventive controlled atmosphere furnace, and a side view of a preheating chamber. As shown in FIG. 1, the inventive controlled atmosphere furnace includes a preheating chamber 1, a brazing chamber 2, atmosphere shutter chambers 3, 4 disposed forward and rearward of the brazing chamber 2, respectively, and a conveyor device 5 for conveying articles 11 to be brazed while passing through these chambers 1, 2, 3 and 4. The article 11 to be heated is typically a heat exchanger shown in FIG. 5.

To the preheating chamber 1 for preheating the article 11 such as a heat exchanger prior to being brazed, a circulation duct 8 is connected for forming a closed loop for circulating combustion gas generated from a gas burner 71. In this regard, in the drawing, the circulation duct 8 is branched leftward and rightward to blow the combustion gas from left and right of the preheating chamber 1, and a tip nozzle 8a is attached to a tip end of the respective branch of the circulation duct 8. A gas burner chamber 7 provided with a gas burner 71 and a circulation fan 6 are disposed in the closed loop. Accordingly, the combustion gas generated from the gas burner 71 is fed from the gas burner chamber 7 to the preheating chamber 1 by the circulation fan 6 and heats the article 11 conveyed by the conveyor device 5 in the preheating chamber 1, after which the combustion gas returns to the gas burner chamber 7. In this case, combustion air for the gas burner 71 is taken in from outside. In this regard, in FIG. 1, reference numeral la denotes an entrance of the preheating chamber, through which the article 11 is introduced into the preheating chamber 1.

The positional relationship between the tip nozzle 8a of the circulation duct 8 and the article 11 is such that when the article 11 is a heat exchanger, the left and right tip nozzles 8a are preferably disposed to confront opposite tank portions 11a and 11b having a larger heat capacity. In this regard, in FIG. 5, reference numeral 11c denotes a core section of the heat exchanger 11.

In the preheating chamber 1, a temperature sensor 9 is provided for issuing a temperature signal to a controller 10. The controller 10 controls the combustion rate of the gas burner 71 and the blast rate of the circulation fan 6 based on the temperature signal. In such a manner, hot combustion gas generated by the gas burner 71 is made to circulate by the circulation fan 6 through the circulation duct 8 disposed opposite to the articles 11 to be heated, during which the combustion rate of the gas burner and the combustion gas circulation rate of the circulation fan 6 are controlled.

The brazing chamber 2 in which the brazing of the article 11 is carried out has an electric heating source for heating the article to the brazing temperature, for example, 600° C. The brazing chamber 2 is filled with non-oxidation atmospheric gas, such as N₂ gas. To seal this non-oxidation atmosphere, the atmosphere shutter chambers 3 and 4 are provided forward and rearward of the brazing chamber 2, respectively. A plurality of metallic curtains 12 hang down in the respective atmosphere shutter chamber 3, 4.

Also, a speed of the conveyor device 5 such as a conveyor for continuously transporting the articles 11 through these chambers 1, 2, 3 and 4 is controlled by a controller not shown.

The flux used for the prior art brazing is of a powder type or a liquid type and merely placed on a tube of a heat exchanger, whereby it is liable to be blown off by the combustion gas blowing from the gas burner. On the other hand, flux used in the present invention is mixed with resinous binder and the mixture is coated on an aluminum tube prior to being brazed. Thus, the flux is not blown off therefrom even if a strong flow of combustion gas is applied from the gas burner 71.

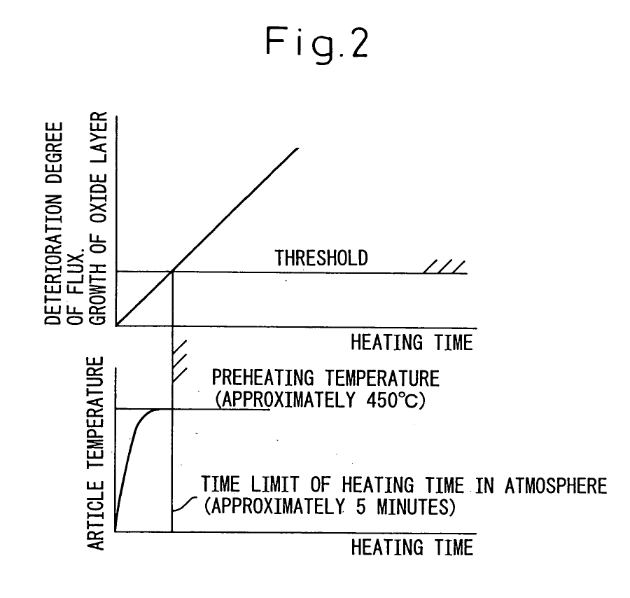

When the inventive controlled atmosphere furnace thus structured is operated, the heating time and the heating temperature in the preheating chamber 1 are decided from graphs shown in FIG. 2. As shown in these graphs, the deterioration degree of flux used for the brazing and the growth of oxide layer of the article are proportional to the heating time in the atmosphere. The allowable heating time in the atmosphere is approximately five minutes.

If the flux is composed of KalF₄ and KalF₅.H₂O mixed in a ratio of 8:2, the following deterioration reaction occurs:

3KalF₄+3H₂O→K₃AlF₆+Al₂O₃+6HF

By the reaction with moisture in air in such a manner, K₃AlF₆ having a melting point as high as 982° C. increases, while KAlF₄ effectively used as flux decreases. This phenomenon is referred to as the deterioration of flux. The effective component in the flux melts before the brazing and removes the oxide layer on the surface of the article. However, if the component having a high melting point increases, it does not melt at the brazing point whereby the removal of the oxide layer becomes impossible.

On the other hand, the growth of oxide layer means that aluminum fluoride or aluminum oxide is formed and grown on the surface of the article and not removed.

A heating temperature in the preheating chamber 1 is chosen at approximately 450° C. This is because if exceeding this value, there is a risk in that the brazing material partially melts, while if the temperature is considerably lower than this value, time is consumed until the article 11 is heated to the brazing temperature.

According to the present invention, as described above, the heating time of the article 11 in the preheating chamber 1 is approximately five minutes and the heating temperature is approximately 450° C. To ensure this heating time, the speed of the conveyor device 5 is controlled so that the article 11 passes through the preheating chamber 1 in approximately five minutes. The temperature of the combustion gas from the gas burner 1 is approximately in a range from 650 to 700° C., which is controlled so that the heating temperature of the article is maintained at approximately 450° C. by adjusting the combustion rate of the gas burner 71 and the circulation rate of the combustion gas by the circulation fan 6 by means of the controller 10.

In this regard, as the interior of the preheating chamber 1 is filled with the combustion gas having an oxygen concentration lower than in the atmosphere, a heating time of approximately five minutes is rather on the safe side in relation to the deterioration of flux and the growth of oxide layer.

As described above, according to the present invention, the controlled atmosphere furnace smaller in size and lower in energy consumption is realized by increasing the temperature of the article to the preheating temperature within a time in which the deterioration of flux used for the brazing and the growth of the oxide layer on the article are not significant.

As the tip nozzle 8a of the circulation duct 8 is opposed to a portion of the article 11 required to be heated, for example, opposite tank portions 11a, 11b of an heat exchanger 11, so that high-speed hot air is directly in contact therewith, it is possible to heat the article 11 at a high speed, resulting in a small-sized furnace body. In this regard, while the preheating chamber 1, the gas burner 71 which is a heat source and the circulation fan 6 are independent from each other in the above embodiment, the gas burner 71 and the circulation fan 6 may be incorporated in the preheating chamber 1 to circulate the combustion gas within the preheating chamber 1 at a high speed and heat the article 11.

Also, as the article is quickly heated, a one-article treatment becomes possible in the brazing process in which a plurality of articles are simultaneously treated in the prior art. This facilitates the change of process conditions for the individual articles, resulting in the possibility of a multi-kind/small production system.

While the invention has been described by reference to specific embodiments chosen for the purpose of illustration, it should be apparent that numerous modifications could be made thereto by those skilled in the art without departing from the basic concept and scope of the invention.

What is claimed is:

1. A controlled atmosphere furnace comprising
a conveyor device for continuously transporting articles to be brazed,
a preheating chamber for preheating the article and a brazing chamber for brazing the article, and
an atmosphere shutter chamber disposed forward and rearward of the brazing chamber for preventing atmospheric gas in the brazing chamber from flowing out, wherein
the article conveyed through the preheating chamber is quickly preheated by the combustion gas, circulating the preheating chamber in a closed-loop flow path, close to a predetermined temperature and within a predetermined time.

2. A controlled atmosphere furnace as defined by claim 1, wherein a gas burner and a circulation fan are provided in the closed-loop flow path for the combustion gas.

3. A controlled atmosphere furnace as defined by claim 2, wherein the quick heating is carried out by controlling the gas burner and the circulation fan.

4. A controlled atmosphere furnace as defined by claim 1, wherein a speed of the conveyor device is controlled so that the article passes through the preheating chamber within a predetermined time.

5. A controlled atmosphere furnace as defined by claim 1, wherein the atmosphere shutter chamber has a plurality of metallic curtains.

6. A controlled atmosphere furnace as defined by claim 1, wherein the predetermined time is approximately five minutes in view of the deterioration degree of flux in the atmosphere and the growth of oxide layer on the article, and the predetermined temperature is approximately 450° C.

7. A controlled atmosphere furnace as defined by claim 1, wherein a tip nozzle of a circulation duct defining the closed-loop flow path for circulating the combustion gas opens to a portion of the article required to be heated.

8. A method for heating a controlled atmosphere furnace used for preheating articles to be brazed, which are continuously supplied to the atmospheric furnace, prior to being brazed, wherein
the article is quickly preheated to a predetermined temperature, with forcibly circulated combustion gas, within a predetermined time determined in view of the deterioration degree of brazing flux in the atmosphere and the growth of oxide layer on the article.

9. A method for heating a controlled atmosphere furnace as defined by claim 8, wherein the predetermined time is approximately five minutes and the predetermined temperature is approximately 450° C.
